(19) United States
(12) Patent Application Publication
(10) Pub. No.: US 2007/0078561 A1
(43) Pub. Date: Apr. 5, 2007

(54) Cosmetics vending machine

(76) Inventor: Barbara Lorraine Sansone, New York, NY (US)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 11/242,796

(22) Filed: Oct. 3, 2005

(51) Int. Cl. G06F 17/00

(52) U.S. Cl. 700/233

(57) ABSTRACT

Automatic vending of cosmetic products is facilitated by allowing a prospective purchaser to acquire a sample size item corresponding to an offered product. The provision of a sample size item alleviates the anxiety inherent in a decision to purchase a product for which a corresponding result depends on the individual user. Accordingly, potential purchasers can comfortably sample, or test out, a product prior to purchasing so as to ensure compatibility with the individual user.

### FIELD OF THE INVENTION

The present invention relates to cosmetics, and particularly to providing cosmetics by a vending machine.

### BACKGROUND

Vending machines are associated with product retail of soft drinks, cigarettes, videos, and snacks. A common thread running between these products is that they are uniform and predictable. For example, a soft drink that is labeled “lemon iced tea” is going to taste like lemon iced tea in the same manner a chocolate bar is going to taste like chocolate. Hence, vending machines are appropriate since the consumer has a good sense of what the product experience will be like. However, as to products for which the product experience depends on consumer attributes, vending technology is more difficult to implement since the consumer has no way of predicting how the product will perform. For example, a hair product may be suitable to a first group consumers having a first hair type but not suitable to a second group associated with a second hair type. Therefore, most often such products are purchased at a store where the consumer can consult a sales associates as to the appropriateness of a product or perhaps test the product by using a tester. As a second example, a lipstick may appear differently on women with different skin type or color.

Sample size products are available for some products, such as perfume, or lip-gloss. These samples are usually available at a store where a corresponding product is available for purchase or as part of a mail advertising campaign. Consumers are generally receptive to product samples as they allow the consumer to determine product compatibility without purchasing the complete product quantity. Therefore, there is a need for a system for allowing consumers to purchase products with the convenience of a vending machine while allowing for predictable product experience commonly associated with product sampling.

### SUMMARY

Accordingly, the present invention provides for a cosmetics vending machine which delivers product samples corresponding to at least some of the available products. The product samples allow consumers to determine product compatibility prior to purchasing the full quantity product. The system of the present invention delivers product samples by various processes including those associated with cash payment, member account, and credit transaction. In one embodiment, the product sample contains a fractional quantity of a substance identical to the substance contained in the corresponding product.

### BRIEF DESCRIPTION OF THE DRAWINGS

FIG. 1 illustrates a cosmetics vending machine of the invention;

FIG. 2 illustrates a circuit diagram of a vending machine control circuit in the vending machine of FIG. 1;

FIG. 3 is a flow diagram illustrating the operation of the vending machine of FIG. 1; and

FIG. 4 illustrates a pair of product sample packaging configurations.

### DETAILED DESCRIPTION

The present invention provides a general system and method for retailing cosmetics by a vending machine interface. Although the discussion is in the context of cosmetics vending, it may be appreciated that the invention is applicable to other products where consumer sampling is conducive to sales. Specifically, the discussion below describes a vending machine configuration where product samples are available for each available product. As may be appreciated, the configuration may be altered to only provide samples for some of the available products while still following the teachings of the invention.

The structure of a vending machine of the invention will first be discussed by reference to an illustration of a front panel from an exemplary vending machine which is configured to allow for the purchase of cosmetic products as well as allow for sampling of each product by a corresponding sample size item. The operation of the vending machine will then be discussed by reference to a flow diagram of a process which provide several options to customers who wish to acquire sample size items. Next, the structure of example sample size items will be discussed by reference to illustrations of sample packaging configurations. Finally, a circuit layout for controlling the operation of the vending machine is discussed.

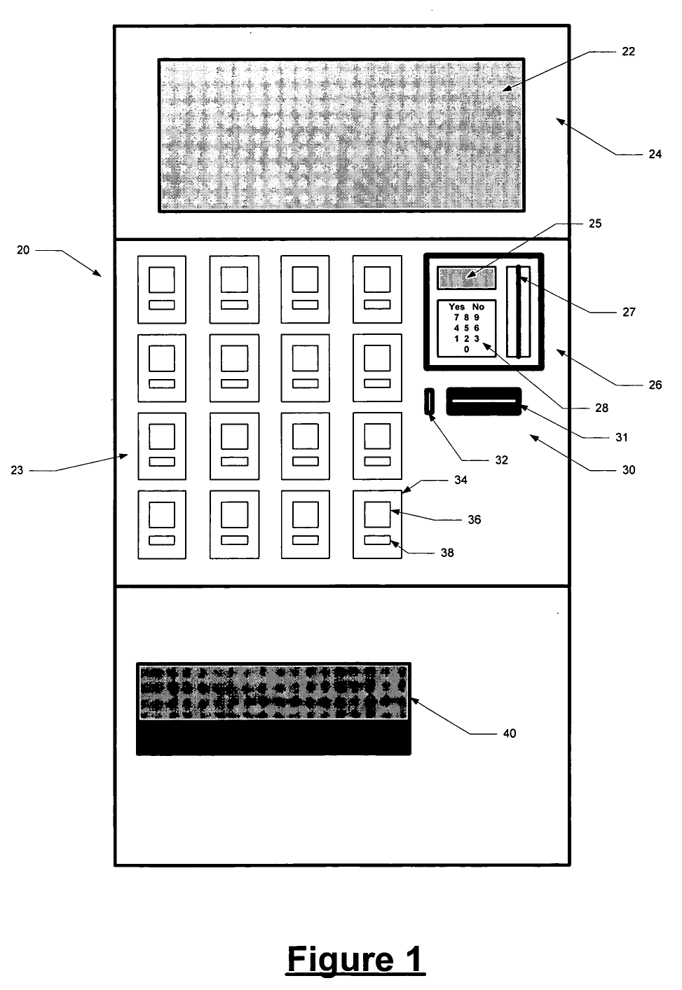

FIG. 1 illustrates a front panel 20 of a vending machine in accordance with one embodiment of the invention. The front panel 20 includes an advertisement portion 24, a product display and sampling portion 23, an information display portion 25, a payment portion 26, and a vending slot 40. The advertisement portion 24 is configured to allow for insertion of advertisement banner 22 to promote a specific product or the vending machine service as a whole. Alternatively, the advertisement portion 24 includes a video screen (not shown) displaying product advertisements and segments relating to product use and application.

The product display and sampling portion 23 includes a plurality of product cells. Each product cell 34 includes an areas for displaying a product identifier indicia 36, such as a logo or other indicator, and a slot for a sample item 38. In another embodiment, the product cell 34 only includes a product identifier and the sample item is provided by way of the vending compartment 40, as discussed below with respect to product vending.

The payment portion 26 facilitates consumer interaction so as to consummate a payment transaction. In one embodiment, the vending machine is configured to allow for consumer purchase of sample items. Hence, a consumer can purchase a sample item prior to purchasing a corresponding product. In another embodiment, the payment portion 26 is only used to facilitate payment for products while samples are provided on the basis of limited credit or by reference to a customer account (discussed below). The payment portion 26 preferably includes a numerical keypad as well as specific function buttons such as “yes,” “no,” “cancel,” etc. Furthermore, the payment portion 26 includes a cash receptor 30 for accepting cash payments. The cash receptor 30 includes a bill acceptor 31 and a coin slot 32. The structure and operation of such cash receptor 30 configurations are known in the art. The payment portion 26 further includes a card reader 27 for reading magnetically encoded card data.

A vending compartment 40 is provided to allow consumer access to purchased products. As is known in the art, in a first operative mode, the vending compartment 40 preferably functions to receive product from the product vending mechanism into its interior portions while preventing customer access to the same interior portions. In a second operative mode, the vending compartment 40 allows customer access to the interior portions while hindering access from within the interior portions to the product vending mechanism.

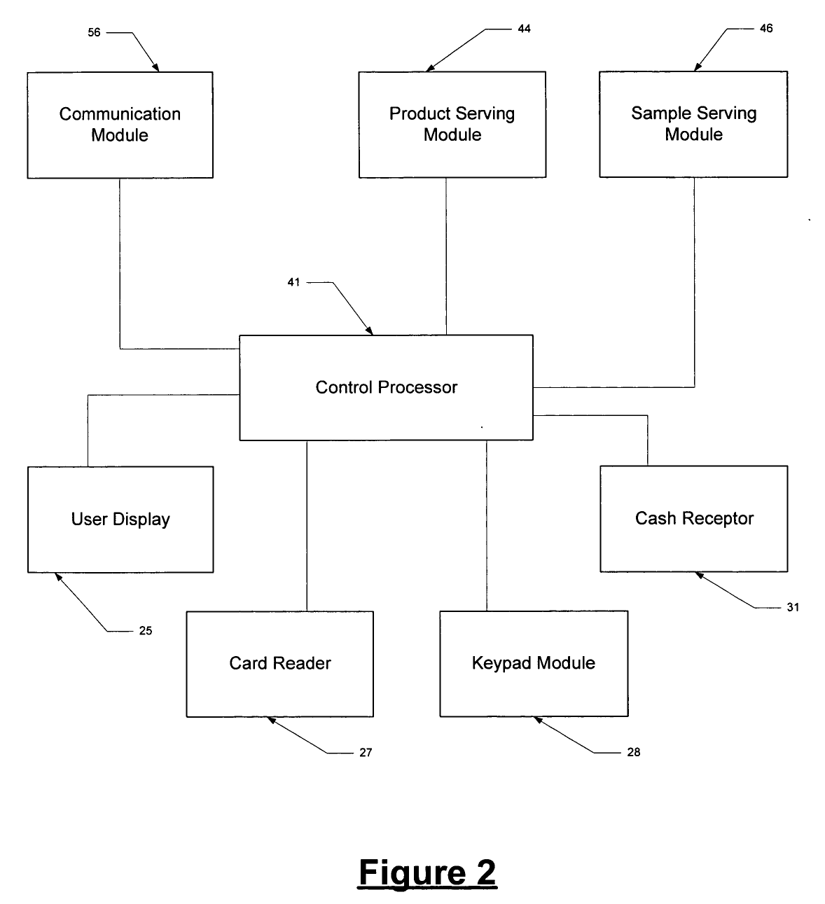

FIG. 2 illustrates the logical elements associated with a vending machine in accordance with an embodiment of the invention. The vending machine includes a control processor 41, a product serving module 44, a sample serving module 46, a cash receptor 31, a keypad module 28, a card reader 27, a user display 25, and a communication module 56.

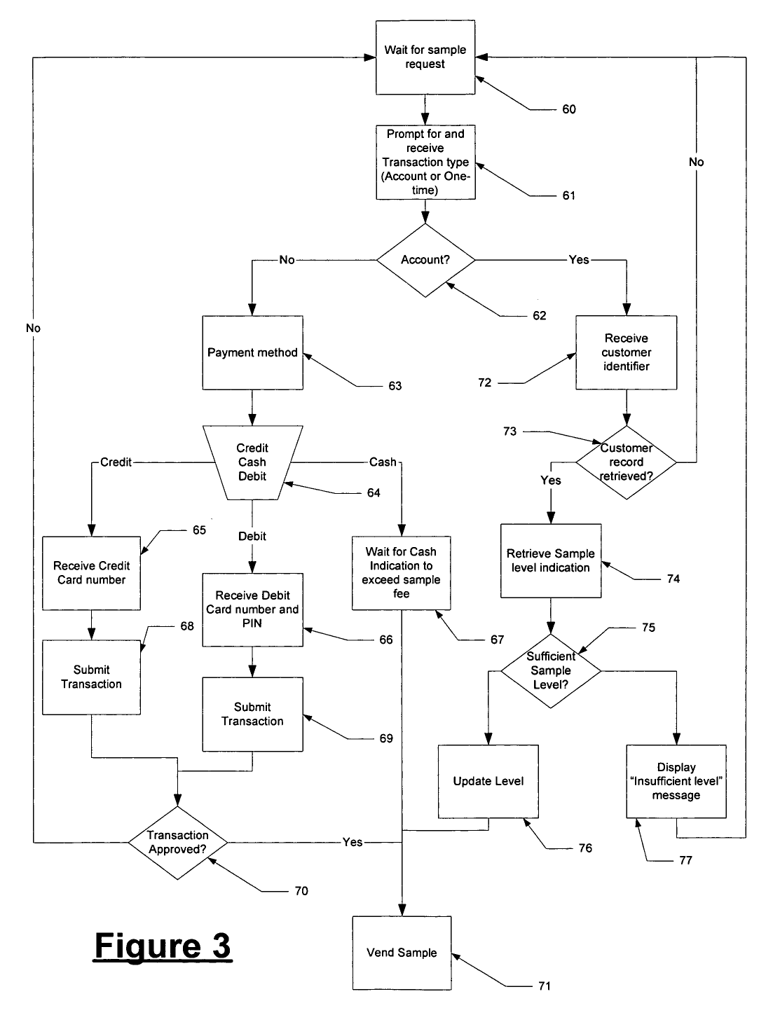

The control processor 41 executes instruction implementing a control algorithm for delivering products and corresponding samples to customers. In one embodiment, the control processor 41 is associated with an instruction set and a non-volatile memory storing a control program. The control program is preferably implemented by reference to the particular processor and corresponding instruction set selected for the vending machine. Accordingly, the specific control program is not essential to understanding of the present invention. In one embodiment, the control program executed by the control processor 41 implements steps associated with the processor in the algorithm discussed below by reference to the flow diagram of FIG. 3. The control processor 41 further includes links to communicate with the logical modules of the vending machine.

The communication module is coupled to the control processor 41 by a data link to allow the control processor to communicate with external systems. The communication module is configured to establish a communication link with an external server (not shown) and deliver data between the control processor 41 and an external server (not shown). In one embodiment, the communication module 56 includes a modem for facilitating a communication link over a telephone communication link. In another embodiment, the communication module 56 includes a network adapter for facilitating a communication link over a local area network or a wide area network, as is known in the art. Once a communication link is established by the communication module 56, the control processor 41 transmits and receives data to and from the external server that is coupled to the communication module. In one embodiment, the control processor 41 employs this communication link to transmit account identifiers to a credit clearing service when authorizing credit card transactions. In another embodiment, the control processor 41 employs the communication link to query a customer records database in a backend server associated with the vending merchant. As may be appreciated, in some implementations the communication link is employed by other modules of the vending machine to facilitate respective functionality such as configuration or software updates.

The product serving module 44 is coupled to the control processor 41 to facilitate product delivery in response to instructions from the control processor. In one embodiment, the control processor 41 transmits data to the product serving module to indicate a product to be delivered to the customer. In response to the control processor data, the product serving module 44 preferably actuates a mechanism which delivers the selected product to the customer. Details of the mechanism are not essential to the invention as various mechanical devices may be employed to deliver product as is known in the art.

The sample serving module 46 is coupled to the control processor 41 facilitate sample delivery in response to instructions from the control processor. The sample serving module 46 preferably responds to data from the control processor 41 to deliver samples to a customer. In response to the control module data, the sample serving module 46 preferably actuates a mechanism which delivers the selected sample to the customer. In one embodiment, the sample serving module 46 delivers a sample by employing a mechanism similar to that used to deliver products as discussed above with respect to the product serving module. In another embodiment, illustrated in FIG. 1, the sample serving module 46 employs a different mechanism for delivering samples which is specially made to deliver sample sized items. In the embodiment illustrated in FIG. 1, the sample serving module 46 delivers samples to dedicated sample opening below each product display portion. Specific details as to the mechanical structure of such sample serving module 46 will be apparent to those of skill in the art.

The user display 25, card reader 27, Keypad module 28, and cash receptor 31 are used to facilitate transactions for the purchase of products or for the provision of samples. The control processor 41 employs the display module 54 to communicate a status to the customer as well as to indicate customer selection. In one embodiment, the control processor 41 provides a display of text corresponding to a selected product code prior to initiating a payment portion of the transaction. In one embodiments, the control processor 41 provides instructions and prompts to the customer by way of the user display 25. As may be appreciated, the particular implementation of the customer interaction algorithm will dictate how the user display 25 is used and is not essential to understanding the invention. The keypad module 28 is used to allow the customer to submit data to the control processor. The keypad module 28 preferably includes both numerical keys as well as dedicated function keys such as “Yes,” “No,” and “Cancel.” The card reader 27 is used to decode magnetic data encoded on magnetic strips used in debit and credit cards. The card reader 27 transmits the decoded card data to the control processor as part of a debit or credit transaction.

FIG. 3 is a flow diagram illustrating the operation of a vending machine of the invention when delivering a sample to a customer. The process initiates with a wait state (Step 60). One possible trigger to move the process out of the wait state is a user request for a sample item. In one embodiment, such user request is detected by identifying an item code received by the control processor as associated with a sample. The process prompts the customer for a transaction type indication (Step 61). In one embodiment, two transaction types are available, account and one-time. An account based sample provision transaction is one where a sample is provided to a customer by reference to data in an account associated with the customer. In one embodiment, account data includes an indicator for the number of samples available to the customer. In some embodiments, the number of samples is incremented by reference to customer activity such as in response to product purchases. A one-time based sample provision transaction is one where a sample is provided to a customer in without reference to account or other tracking data. In one embodiment, the one-time transaction is in response to direct payment from the customer for each delivered sample. In another embodiment, the one-time transaction is free of charge but is limited in other ways, such as for example by restricting the number of sample per hour that can be obtained from a vending machine.

The process determines whether the customer transaction indication is for an account based transaction (Step 62). If the transaction is an account based transaction the process generated data for displaying a prompts requesting a customer identifier by way of the keypad entry (Step 72). In another embodiment, the displayed prompt request that the customer swipe a magnetic card through the magnetic card reader so as to receive the decoded account identifier from the card reader module. The process searches for a corresponding customer record in the customer database (Step 73). In one embodiment, the control processor employs the communication module to submit a query to a customer database storing customer records. If a customer record is not located, the control processor preferably generates a message indicating that the customer identifier is not valid and the transaction has been cancelled. The control processor return to the wait state of the process (Step 60). If a customer record is located in response to the submission of the customer identifier, the control processor retrieves a sample level indicator from the customer record (Step 74). The sample level indicator preferably corresponds to the number of samples a customer can retrieve from a vending machine prior to exhausting all available sample credit. The control processor determines whether the present sample level indication is sufficient to allow for delivery of the selected sample to the customer (Step 75). In one embodiment, all sample deliveries result in a single unit decrementing of the sample credit indicator. In other embodiments, samples may be associated with varying credit levels, corresponding to relative value, so as to result in varying decrementing of the sample level indicator. Accordingly, in this embodiment, the control processor ensures that the sample level indicator is at least greater than the relative value of the selected sample. In the embodiment where all samples are associated with single unit decrementing, the control processor ensures that the sample level indicator is greater than one. If the sample level is not sufficient to provide the selected sample to the customer, the control processor generates data to display an “insufficient credit” message by the user display and move to the process wait state (Step 77). If the sample level is sufficient, the control processor updates the customer record by replacing the sample level indicator with an updated level indicator resulting from delivery of the selected sample (Step 76). The processor then proceeds to transmit data to the sample delivery module to cause actuation of the mechanical sample delivery element corresponding to the selected sample (Step 71).

In one embodiment, samples are associated with item prices such that customers may purchase samples. If such option is available in the vending machine, the customer may select to proceed with acquiring a sample for a fee. The control processor prompts the customer to select a payment method from a plurality of available methods (Step 63). In one embodiment, the customer selects from three payment methods, including credit, cash, and debit (Step 64). If credit payment is selected, the control processor generates data which causes the display to generate a message instructing the customer to swipe a credit card in the credit card reader. The control processor receives the decoded account number from the card reader (Step 65). The control processor employs the communication module to transmit a credit card payment request to a credit clearing service as is known in the art (Step 68). If the transaction is approved and properly completed, the control processor receives such indication from the communication module (Step 70). The control module then instructs the sample vending module to deliver the selected sample to the customer (Step 71).

If the selected payment method is debit card, the control module generates data which causes the display to instruct the customer to swipe a debit card and enter a corresponding PIN number as is known in the art. The control processor receives the decoded card data and PIN (Step 66). The control processor employs the received data to submit a debit transaction to a debit transaction clearing service (Step 69). If the debit transaction is approved and successfully completed, the control processor receives a corresponding indication from the communication module (Step 70). The control processor proceeds to transmit data to the sample delivery module to provide the selected sample to the customer (Step 71).

If the selected payment method is cash, the control processor generates data which causes the display to instruct the customer to provide cash in the required amount to the cash receptor, as is known in the art. Once the control processor receives an indication that sufficient cash has been received by the cash receptor (Step 67), the control processor transmit data to the sample delivery module to provide the selected sample to the customer (Step 71).

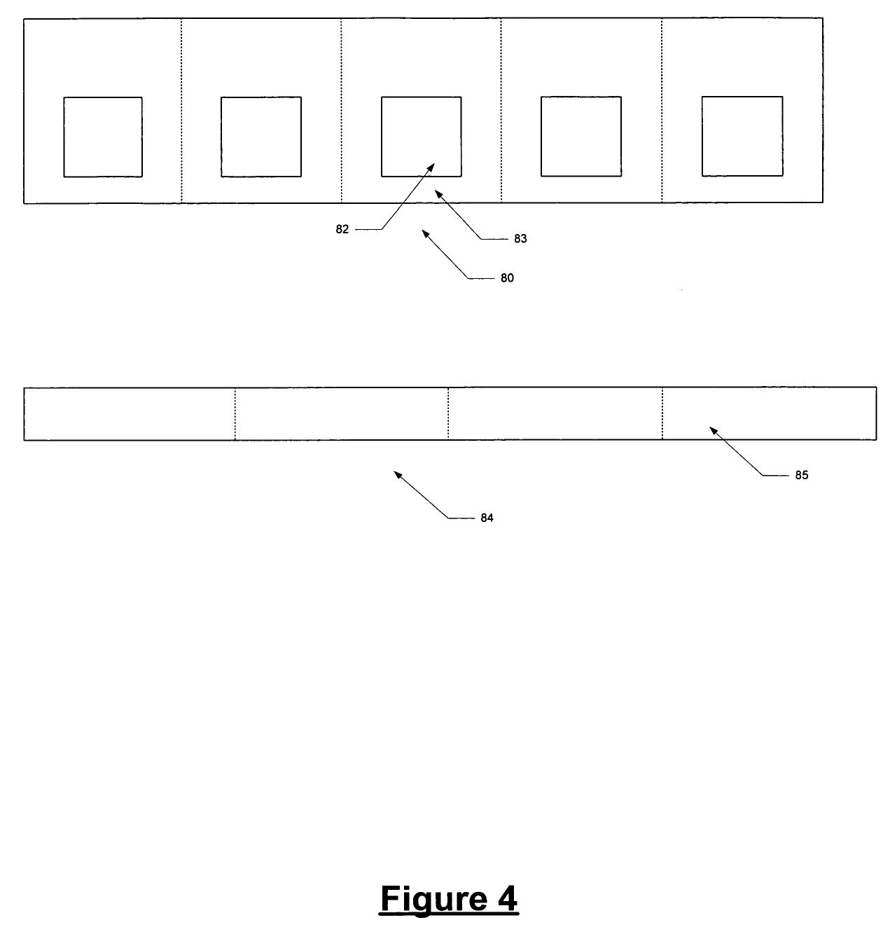

FIG. 4 illustrates sample packaging for samples in a vending machine of the invention. A first packaging 80 includes a product compartment 82 and a display backing 83. The display backing 83 preferably includes the corresponding product name as well as instructions for use, if applicable. The product compartment 82 preferable comprises a front face made of clear material such as clear plastic and a rear face which may be opened by the customer. In one embodiment, the product compartment back (not shown) is metal foil which can be easily peeled away to allow for customer access to the sample material. A second packaging 84 is for a perfume or other scented product. The packaging includes a stripe of an absorbent material 85 configures to release a substance in response to exposure to the open environment. Preferably the second product packaging is maintained within a sealed delivery mechanism which prevents the activation of product release until each sample is delivered.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A cosmetics vending apparatus, comprising:
A cosmetic product serving module for delivering a cosmetic product to a user by way of a vending compartment;
A cosmetic sample serving module for delivering a cosmetic sample to said user, the cosmetic sample associated with at least one cosmetic product available to said product serving mechanism; and
A control module coupled to said product serving mechanism and to said sample serving mechanism to control delivery of said sample and said product in response to user data entry received by said control module.

2. The cosmetics vending apparatus of claim 1, further comprising a data entry module including an alphanumeric keypad.

3. The cosmetics vending apparatus of claim 2, wherein said data entry module further comprises a credit card reader.

4. The cosmetics vending apparatus of claim 2, wherein said data entry module further comprises a cash receptor.

5. The cosmetics vending apparatus of claim 1, further comprising a communication module to communicate with a back-end database.

6. The cosmetics vending apparatus of claim 1, further comprising a display screen for displaying data to said user.

7. The cosmetics vending apparatus of claim 1, wherein said cosmetic sample contains a fractional quantity of the same substance that is included in the cosmetic product corresponding to the sample.

8. The cosmetics vending apparatus of claim 1, wherein said cosmetic product is intended for application to human skin.
